(19) United States
(12) Patent Application Publication
(10) Pub. No.: US 2004/0040946 A1
(43) Pub. Date: Mar. 4, 2004

(54) Heating element embedded material for seats and other uses

(76) Inventor: Roger F. Nation, Brandon, FL (US)

Correspondence Address: Edward M. Livingston, Esq., 628 Ellen Dr., P.O. Box 1599, Winter Park, FL, 32790, US

(21) Appl. No.: 10/230,603

(22) Filed: Aug. 28, 2002

(51) Int. Cl. H05B 3/34

(52) U.S. Cl. 219/217; 219/549; 219/228

(57) ABSTRACT

A heating-element-embedded material has a lateral heating element (1) embedded in furniture material (2) which can be used for covering seats and other furniture and for making heating articles of furniture (3). The lateral heating element has series-parallel heating-resistor conveyance of current from an input terminal (4) to a return terminal (5). The lateral heating element can include a resistance-wire net (14), a thin sheet (20), a plurality of parallel thin strips (22), a plurality of parallel thin lines (23), a plurality of parallel expanded helical or zigzag lines (24), a plurality of parallel thin zigzag strips (25) or other generally series-parallel conveyance within or on either side of the furniture material. The furniture material can be rubberlike, leatherlike, vinyl-like, cloth-like, smooth, rough, moisture-proof, permeable, impermeable or made otherwise for heated-surface use. Heating-article uses can include heating pads (17), seat covers (26), pillow covers (27), quilts (28), mattress covers (29) and wall covers (30).

### BACKGROUND OF THE INVENTION

This invention relates to electrical-resistance heating elements and more particularly to leather-like or rubber-like heating-element-embedded material and heating articles made with it for smoothness, thinness, moisture resistance, pliantness, safety and long use life.

Known electrical heating elements for heating seats, furniture and pads employ a generally zigzag, meandering or other patterned electrical-series current that is routed from-end-to-end of a strand or yarn of electrical-resistance wire to generate heat. This necessitates thickness of heating material for furniture. It is not advantageous for or conducive to thin, smooth or textured covering material with a heating element embedded unobtrusively in it for covering seats or furniture and for making thin heating articles, sheets or pads.

There is no known electrical heating element embedded in furniture-covering material as taught by this invention.

Examples of most-closely related known but different devices are described in the following patent documents:

| U.S. Pat. No. | Inventor | Issue Date |
|---|---|---|
| 4,825,048 | Altmann, et al. | Apr. 25, 1989 |
| 2,731,542 | Daniels | Jan. 17, 1956 |
| 5,516,189 | Ligeras | May 14, 1996 |
| 4,628,188 | Andreasson | Dec. 9, 1986 |
| 4,590,359 | Möbius | May 20, 1986 |
| 4,044,221 | Kuhn | Aug. 23, 1977 |
| 4,964,674 | Altmann, et al. | Oct. 23, 1990 |

### SUMMARY OF THE INVENTION

Objects of patentable novelty and utility taught by this invention are to provide heating-element-embedded material which:

contains resistance-heating elements in furniture material which can have predetermined furniture-covering thinness, pliantness, moisture imperviousness, breathing porosity and texture designedly;

can be sized, shaped and articulated into predetermined heating articles of furniture designedly; and

is inexpensive and long-lasting.

This invention accomplishes these objectives with a heating-element-embedded material having a lateral heating element embedded in furniture material which can be used for covering seats and other furniture and for making heating articles of furniture. The lateral heating element has series-parallel heating-resistor conveyance of current from an input terminal to a return terminal. The lateral heating element can include a net, sheet, perforated-sheet, line-juxtaposition, strip-juxtaposition, yarn-juxtaposition, helix-juxtaposition, zigzag-juxtaposition or other generally series-parallel conveyance within or on either side of the furniture material. The furniture material can be rubberlike, leatherlike, vinyl-like, cloth-like, smooth, rough, moisture-proof, permeable or impermeable. The heated-surface use can be for seat covering, furniture covering, mattress covering, quilting, pillow covering, heating pads, wall covering and other heating articles of furniture.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a partially cutaway side view of a heating article of furniture or portion thereof having a lateral heating element that is a resistance-wire net oriented with oblique strands embedded in furniture material;

FIG. 2 is a side view of a representation of a DC current outlet that can include a receptacle for a cigarette lighter on a vehicle;

FIG. 3 is a partially cutaway fragmentary side view of a converter for converting DC to AC for using a DC plug on the heating article of furniture;

FIG. 4 is a fragmentary side view of a plug of an AC electrical cord for use on AC heating articles of furniture;

FIG. 5 is an edge view of the heating article of furniture showing approximate relative thinness of the heating article of furniture or the furniture material from which it is made in proportion to an electrical cord;

FIG. 6 is a schematic representation of the heating article of furniture or furniture material for making it with two layers of the lateral heating elements being a resistance-wire net embedment-positioned proximate each of two opposite sides of the furniture material;

FIG. 7 is a schematic representation of the heating article of furniture or furniture material for making it with one layer of the lateral heating elements being a resistance-wire net embedment-positioned intermediate the two opposite sides of the furniture material;

FIG. 8 is a partially cutaway side view of the heating article of furniture that is a heating pad having the lateral heating element that is the resistance-wire net oriented with strands orthogonal to an axis of current flow intermediate an input terminal and a return terminal and being positioned in a carrying case;

FIG. 9 is a partially cutaway side view of the heating article of furniture or portion thereof having the lateral heating element that is a thin sheet of resistance material that is optionally perforated for permeability;

FIG. 10 is a schematic representation of the heating article of furniture or furniture material for making it with two layers of the lateral heating elements being the thin sheet of resistance material embedment-positioned proximate each of two opposite sides of the furniture material;

FIG. 11 is a schematic representation of the heating article of furniture or furniture material for making it with one layer of the lateral heating elements being the thin sheet of resistance material embedment-positioned intermediate the two opposite sides of the furniture material;

FIG. 12 is a schematic representation of the heating article of furniture or furniture material for making it with the one of the lateral heating elements being the perforated thin sheet of resistance material embedment-positioned intermediate the two opposite sides of the furniture material;

FIG. 13 is a partially cutaway side view of the heating article of furniture or portion thereof having the lateral heating element that is a plurality of thin strips of resistance material that are embedment-positioned in the furniture material spaced apart predeterminedly edge-to-edge laterally and parallel to flow of current from the input terminal to the return terminal;

FIG. 14 is a schematic representation of the heating article of furniture or furniture material for making it with two layers of the lateral heating elements being the plurality of thin strips of resistance material that are shown from ends and embedment-positioned in the furniture material spaced apart predeterminedly edge-to-edge laterally and parallel to flow of current from the input terminal to the return terminal;

FIG. 15 is a schematic representation of the heating article of furniture or furniture material for making it with one layer of the lateral heating elements being the plurality of thin strips of resistance material that are shown from ends and embedment-positioned in the furniture material spaced apart predeterminedly edge-to-edge laterally and parallel to flow of current from the input terminal to the return terminal;

FIG. 16 is a partially cutaway side view of the heating article of furniture or portion thereof having a lateral heating element that is a plurality of thin single lines or optionally thin yarn lines of resistance material that are embedment-positioned in the furniture material spaced apart predeterminedly side-by-side laterally and parallel to flow of current from the input terminal to the return terminal;

FIG. 17 is a schematic representation of the heating article of furniture or furniture material for making it with two layers of the lateral heating elements being the plurality of thin single lines or optionally thin yarn lines of resistance material that are shown from ends and embedment-positioned in the furniture material spaced apart predeterminedly side-by-side laterally and parallel to flow of current from the input terminal to the return terminal;

FIG. 18 is a schematic representation of the heating article of furniture or furniture material for making it with one layer of the lateral heating elements being the plurality of thin single lines or optionally thin yarn lines of resistance material that are shown from ends and embedment-positioned in the furniture material spaced apart predeterminedly side-by-side laterally and parallel to flow of current from the input terminal to the return terminal;

FIG. 19 is a partially cutaway side view of the heating article of furniture or portion thereof having a lateral heating element that is a plurality of thin expanded helical lines or optionally zigzag lines of resistance material that are embedment-positioned in the furniture material spaced apart predeterminedly side-by-side laterally and parallel to flow of current from the input terminal to the return terminal;

FIG. 20 is a schematic representation of the heating article of furniture or furniture material for making it with two layers of the lateral heating elements being the plurality of thin expanded helical lines or optionally zigzag lines of resistance material that are shown from ends and embedment-positioned in the furniture material spaced apart predeterminedly side-by-side laterally and parallel to flow of current from the input terminal to the return terminal;

FIG. 21 is a schematic representation of the heating article of furniture or furniture material for making it with one layer of the lateral heating elements being the plurality of thin expanded helical lines or optionally zigzag lines of resistance material that are shown from ends and embedment-positioned in the furniture material spaced apart predeterminedly side-by-side laterally and parallel to flow of current from the input terminal to the return terminal;

FIG. 22 is a partially cutaway side view of the heating article of furniture or portion thereof having a lateral heating element that is a plurality of thin zigzag strips of resistance material that are shown from ends and embedment-positioned in the furniture material spaced apart predeterminedly edge-to-edge laterally and parallel to flow of current from the input terminal to the return terminal;

FIG. 23 is a schematic representation of the heating article of furniture or furniture material with the lateral heating elements being a plurality of thin zigzag strips of resistance material that are shown from ends and embedment-positioned in the furniture material spaced apart predeterminedly edge-to-edge laterally and parallel to flow of current from the input terminal to the return terminal;

FIG. 24 is a schematic representation of the heating article of furniture or furniture material for making it with the lateral heating elements being the plurality of thin zigzag strips of resistance material that are shown from ends and embedment-positioned in the furniture material spaced apart predeterminedly edge-to-edge laterally and parallel to flow of current from the input terminal to the return terminal;

FIG. 25 is a side elevation view of a seat having a seat cover as the heating article of furniture;

FIG. 26 is a side elevation view of a pillow having a pillow cover as the heating article of furniture;

FIG. 27 is an edge view of a quilt as the heating article of furniture;

FIG. 28 is a side elevation view of a mattress having a mattress cover as the heating article of furniture; and

FIG. 29 is a side elevation view of a wall cover as the heating article of furniture;

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. | Lateral heating element |
| 2. | Furniture material |
| 3. | Heating articles of furniture |
| 4. | Input terminal |
| 5. | Return terminal |
| 6. | Layer connector |
| 7. | Return connector |
| 8. | Current distributor |
| 9. | Electrical cord |
| 10. | DC plug |
| 11. | AC plug |
| 12. | Vehicle lighter socket |
| 13. | Converter |
| 14. | Resistence-wire net |
| 15. | First strand |
| 16. | Second strand |
| 17. | Heating pad |
| 18. | Sanitary bag |
| 19. | Handle |
| 20. | Thin sheet |
| 21. | Perforations |
| 22. | Thin strips |
| 23. | Thin lines |
| 24. | Expanded helical lines |
| 25. | Zigzag strips |
| 26. | Seat cover |
| 27. | Pillow cover |
| 28. | Quilt |
| 29. | Mattress cover |
| 30. | Wall cover |

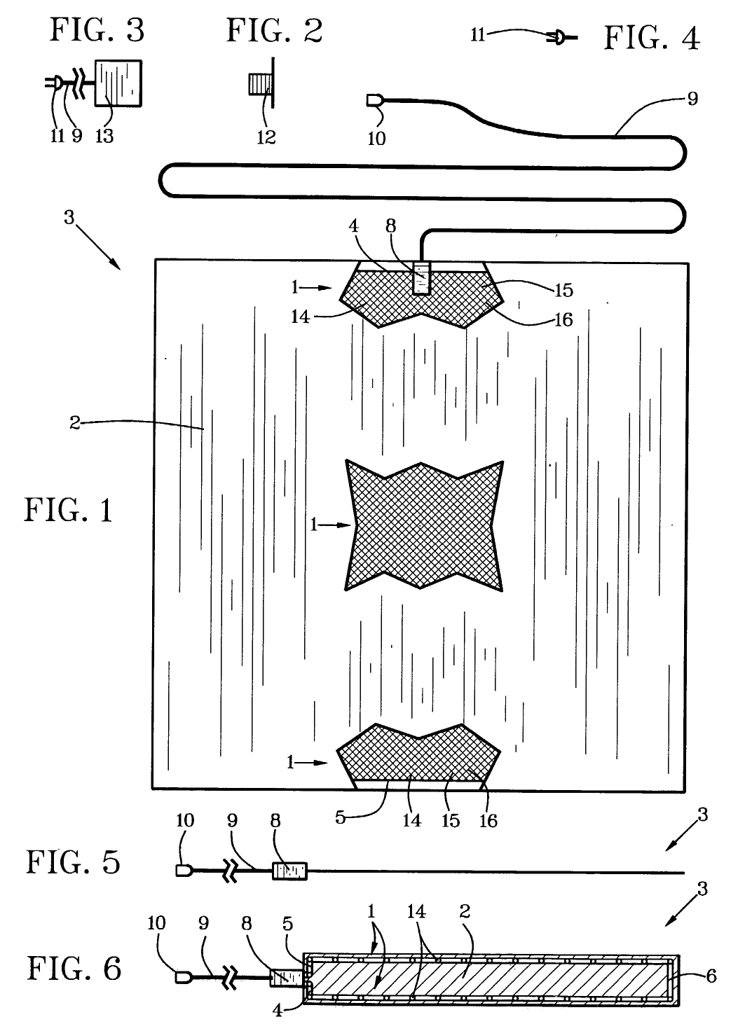

Referring to FIGS. 1-7, the heating-element-embedded material has a lateral heating element 1 embedded in furniture material 2 having predetermined features for making and covering heating articles of furniture 3 designedly. The lateral heating element 1 has series-parallel heating-resistor communication of electrical current intermediate an input terminal 4 and a return terminal 5 on the heating article of furniture 3. The input terminal 4 and the return terminal 5 can be articulated or extended to include lateral lead lines which convey current for series-parallel heating resistance by predetermined lateral heating elements 1.

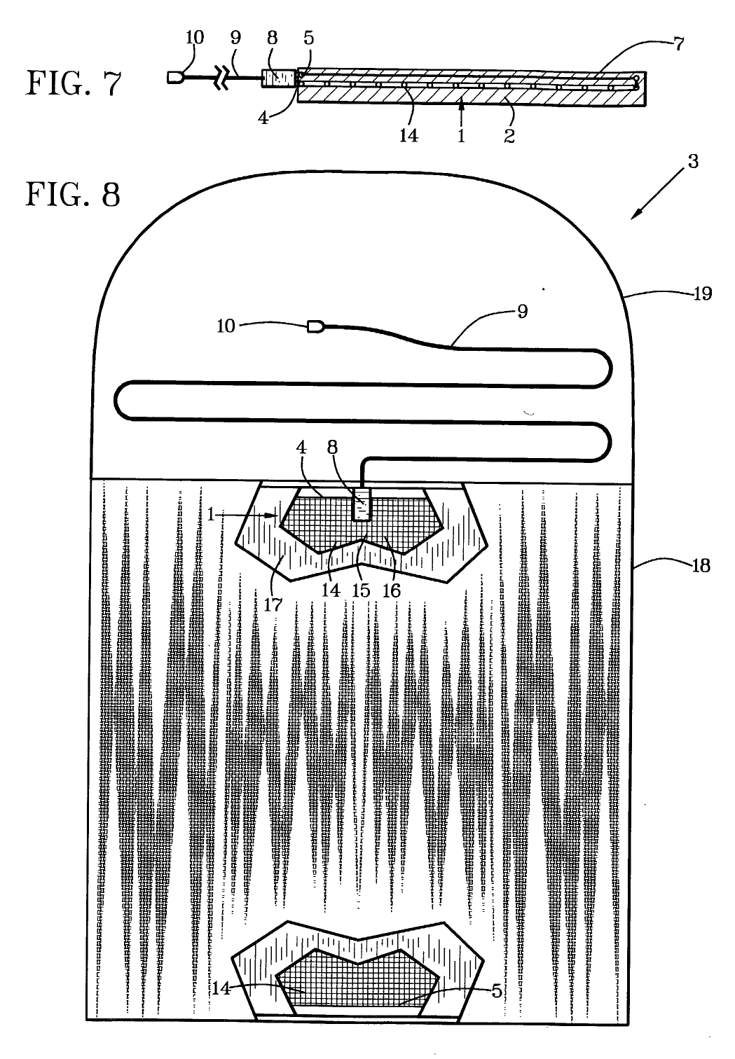

A layer of the lateral heating element 1 can be embedment-positioned proximate each of oppositely disposed sides of the furniture material 2 as shown in FIG. 6. Optionally, a single layer of the lateral heating element 1 can be embedment-positioned in the furniture material 2 predeterminedly intermediate the oppositely disposed sides as shown in FIG. 7. For the two layers, a layer connector 6 can be employed for bridging electrical conveyance between them. For the single layer, a return connector 7 can be employed for bridging electrical conveyance between the return terminal 5 and a current distributor 8. The return connector 7 is preferably embedded in the furniture material 2, although shown outside of the furniture material 2 in FIG. 12 for representation of optionally surface or outside positioning of the return connector 7.

The current distributor 8 is connected to an electrical cord 9 having optionally a DC plug 10 or an AC plug 11. The DC plug 10 can be articulated for connection to a vehicle lighter socket 12 or optionally to a converter 13 for distributing current to the input terminal 4 and returning it from the return terminal 5.

In known prior art, conventional heater elements resistance-convey electrical current in series from an input end to a return end of a conventional resistor element. The conventional resistor element is generally a wire, a yarn of wire or a single-wire helix. Generally, the conventional heater elements are positioned to zigzag from side-to-side of heated areas or portions of heated areas. This is known in the industry as “meandering”. Meandering provides parallel or side-by-side positioning of the conventional heater element, but it is not series parallel as taught by this invention because current travel is still series from-end-to-end of the meandering or variously routed single line. There can be a plurality of meandering series in the conventional practice, but it is only a duplication of the same series flow of current.

The series flow of current in conventional practice has major thickness disadvantages resulting from thickness of the heater elements that is required to resistance-convey current from-end-to-end of the heater elements. Meandering only increases the length and, therefore, thickness of heater element required. Helix construction further increases thickness with diameter of the helix in addition to thickness of helix wire or rod required to resistance-convey current from-end-to-end of a heater-element circuit.

It is not practically or economically possible to construct usably thin furniture-covering material with series-current heater elements. The thickness of series-circuit heater elements requires either thick material to contain it or the formation of ridges to cover over it.

A purpose of this invention, therefore, is to provide series-parallel heating elements which are referred to herein as the lateral heating elements 1. They have series flow of current which is ontologically essential. However, the lateral heating elements 1 also have parallel current travel in a manner taught by this invention.

Included as one embodiment of the lateral heating element 1 is a resistence-wire net 14 that is shown in FIGS. 1 and 6-8. In FIG. 1, the resistance-wire net 14 is oriented with first strands 15 extended obliquely in a direction of a first side of the heating article of furniture 3 and with second strands 16 extended obliquely in a direction of a second side of the heating article of furniture 3. In FIG. 8, the resistance-wire net 14 is oriented with the first strands 15 parallel and the second strands 16 orthogonal to an axis of current flow intermediate the input terminal 4 and the return terminal 5.

In either orientation of the resistence-wire net 14, flow of current is both series from-end-to-end and parallel from-side-to-side in heater-resistance circuitry from the input terminal 4 to the return terminal 5. The first strands 15 and the second strands 16 can be unprecedentedly thin because there are many of them either obliquely or orthogonally side-by-side for series and simultaneously parallel travel of current within a teaching of series parallel by this invention. Also allowing them to be thin is relative shortness in contrast to longer length of meandering series-current lines of the prior art. Thinness of the resistance-wire net 14 embodiment of the lateral heating element 1 allows thinness of the furniture material 2 for structure of the heating articles of furniture 3.

Referring to FIG. 8, the heating article of furniture 3 can include a heating pad 17 which can be used also as a portable seat cover that is positioned removably in a sanitary bag 18 which can be washed and which can be carried with a handle 19 for convenient and sanitary use where and as desired. Preferably but not necessarily, it has the DC plug 10 for hook up to a golf cart or other vehicle with DC current. The heating pad 17 can be as thin as ordinary furniture material 2, purse material or thick cloth for ease of carrying in or out of the sanitary bag 18. The lateral heating element 1 for the heating pad 17 and optionally seat cover can be the resistance-wire net 14 described in relation to either FIG. 1 or FIG. 8 or a selection of other embodiments of the lateral heating element 1 described hereafter.

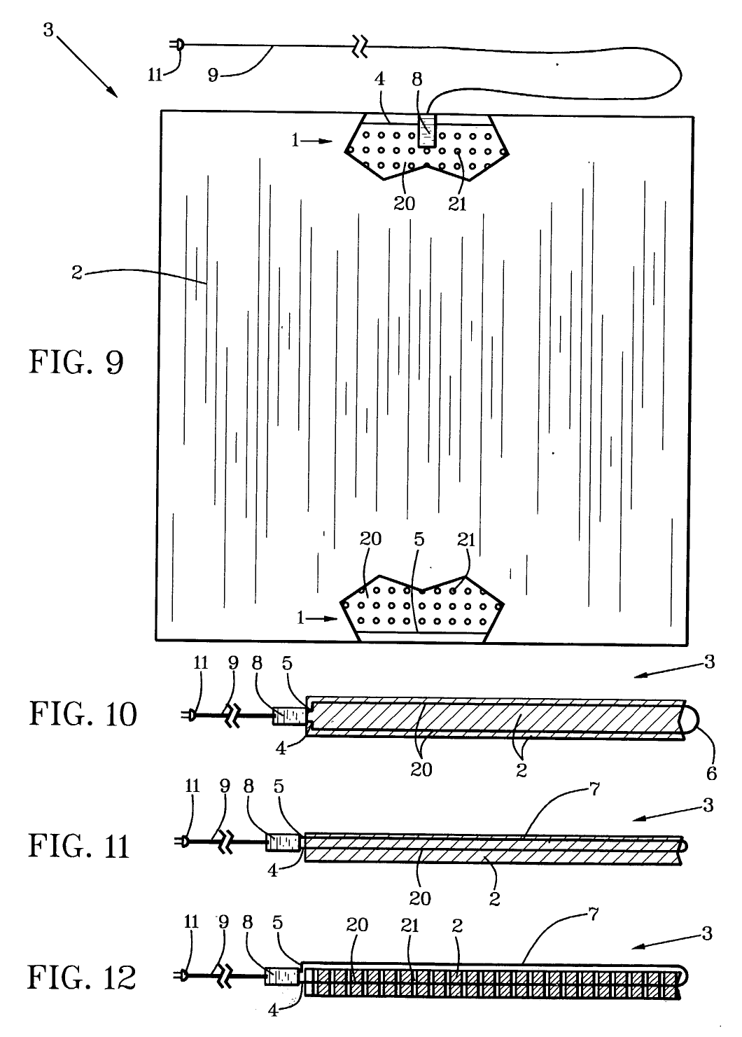

Referring to FIGS. 9-12, the lateral heating element 1 can include a predeterminedly thin sheet 20 of resistence material that optionally can be perforated with perforations 21 for breathing permeability. For two of the thin sheets 20 embedment-positioned proximate opposite sides of the furniture material 2, as shown in FIG. 10, the layer connector 6 or optionally the thin material 20 is employed to bridge circuit routing of current from electrical contact with the input terminal 4 to electrical contact with the return terminal 5 at the current distributor 8. For one of the thin sheets 20 embedment-positioned intermediate the opposite sides of the furniture material 2, as shown in FIGS. 11-12, the return connector 7 is employed to bridge circuit routing of current from electrical contact with the input terminal 4 to electrical contact with the return terminal 5 at the current distributor 8. The embodiment with the one thin sheet 20 without the perforations 20 as shown in FIG. 11 is a good wall cover for cleaner and more efficient heating of rooms of buildings and some types of vehicles than present forced-air electrical, gas, steam or hot-water heating. The embodiment with either the one thin sheet 20 with the perforations 21 as shown in FIG. 12 or with the two thin sheets 20 is a good heating pad 17 or other people cover shown in FIG. 8.

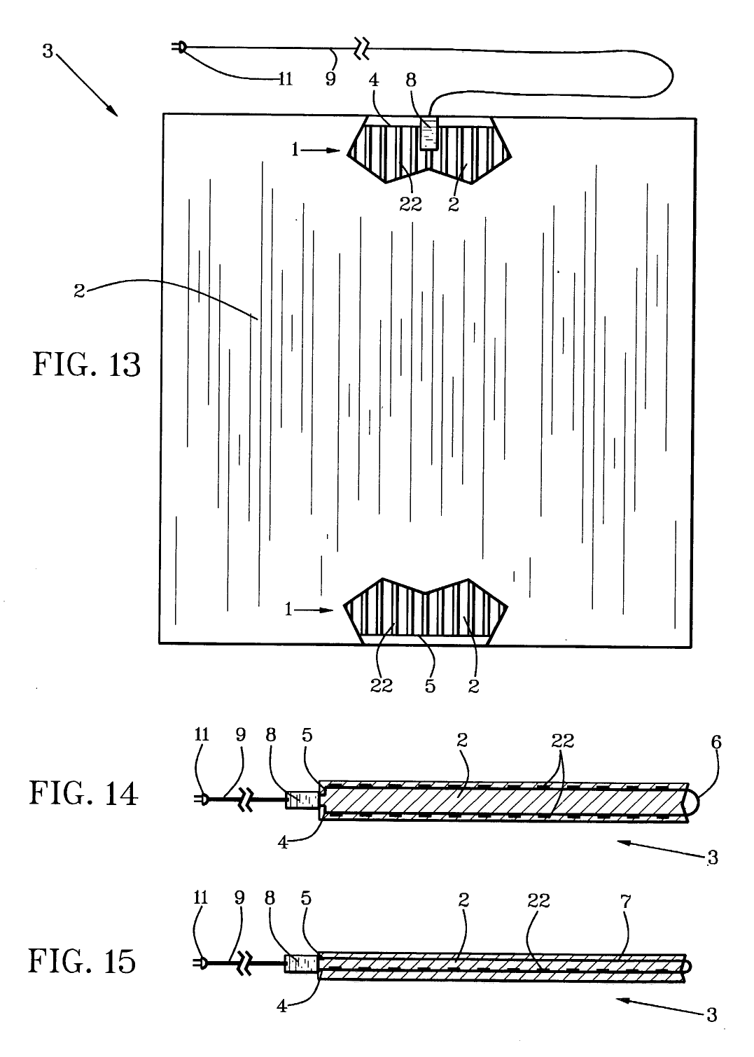

Referring to FIGS. 13-15, the lateral heating element 1 can include a plurality of predeterminedly thin strips 22 of resistance material that are spaced apart predeterminedly edge-to-edge laterally. The input terminal 4 is in electrical communication intermediate the current distributor 8 and input ends of the thin strips 22. For two layers of the thin strips 22 proximate oppositely disposed sides of the furniture material 2, the layer connector 6 connects the two layers. The return terminal 5 is in electrical communication intermediate return ends of the thin strips 22 and the current distributor as shown in FIG. 14. For one layer of the thin strips 22 intermediate the opposite sides of the furniture material 2, the return connector 7 connects the return terminal 5 with the current distributor 8 as shown in FIG. 15.

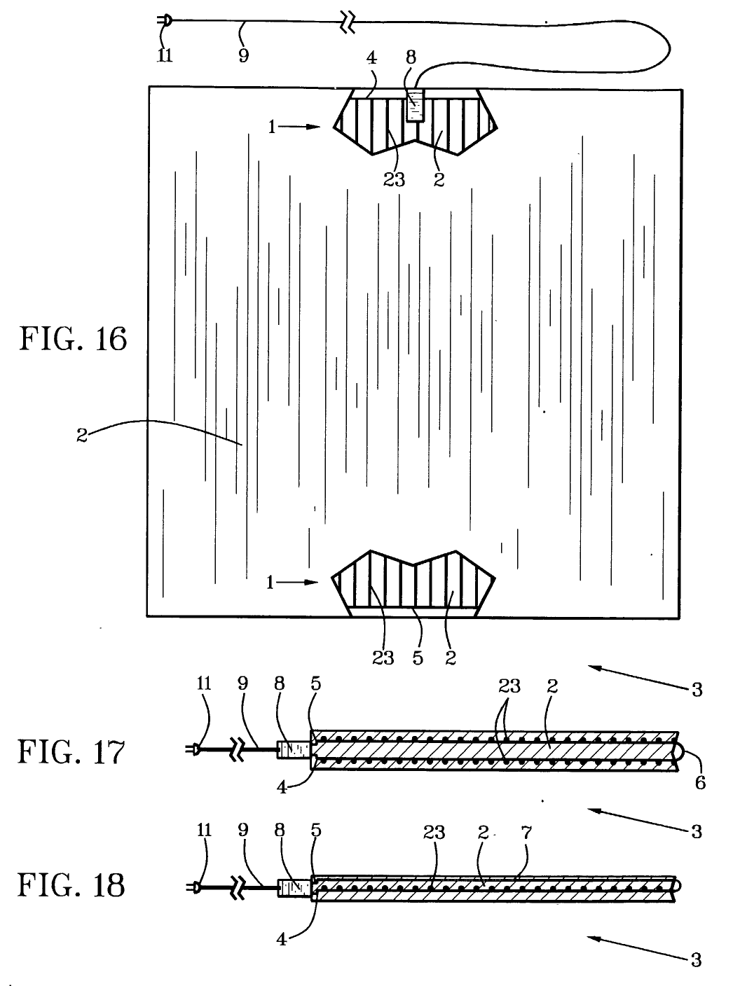

Referring to FIGS. 16-18, the lateral heating element 1 can include a plurality of predeterminedly thin lines 23 which can be thin single lines or thin yarn lines which are not shown separately in the drawings. The single and yarn thin lines 23 of resistance material are spaced apart predeterminedly side-by-side laterally. The input terminal 4 is in electrical communication intermediate the current distributor 8 and input ends of the thin lines 23. For two layers of the thin lines 23 proximate oppositely disposed sides of the furniture material 2, the layer connector 6 connects the two layers. The return terminal 5 is in electrical communication intermediate return ends of the thin lines 23 and the current distributor as shown in FIG. 17. For one layer of the thin lines 23 intermediate the opposite sides of the furniture material 2, the return connector 7 connects the return terminal 5 with the current distributor 8 as shown in FIG. 18.

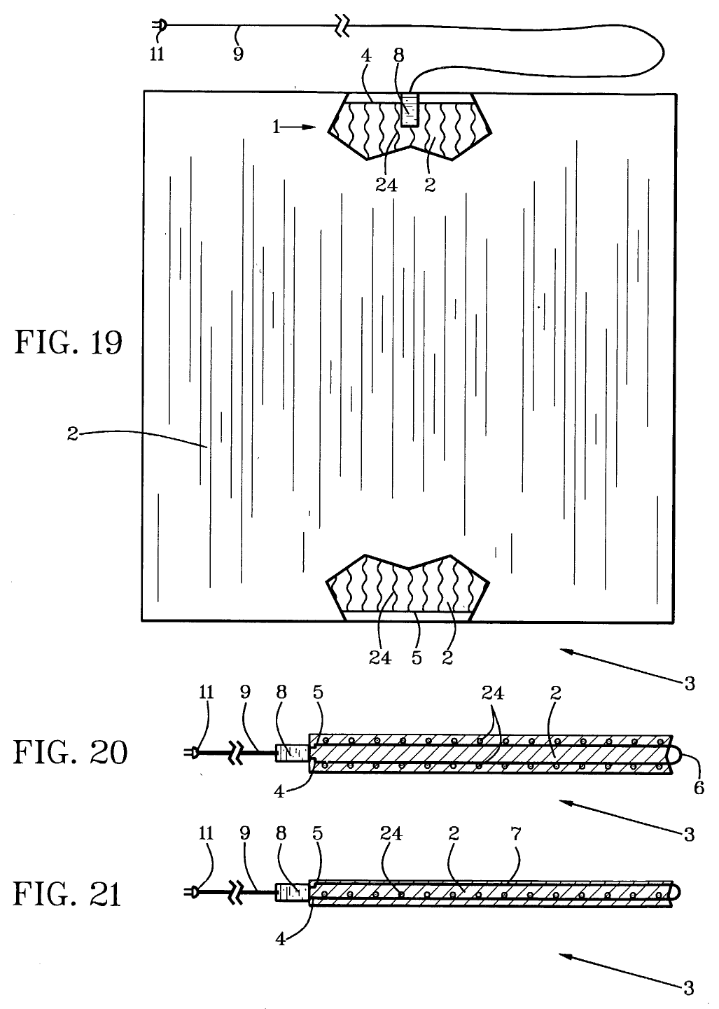

Referring to FIGS. 19-21, the lateral heating element can include a plurality of predeterminedly thin expanded helical lines 24 which can be thin helical lines or thin zigzag lines which are not shown separately in the drawings. The thin zigzag and thin expanded helical lines 24 of resistance material are spaced apart predeterminedly side-by-side laterally. The input terminal 4 is in electrical communication intermediate the current distributor 8 and input ends of the thin zigzag or expanded helical lines 24. For two layers of the thin zig or expanded helical lines 24 proximate oppositely disposed sides of the furniture material 2, the layer connector 6 connects the two layers. The return terminal S is in electrical communication intermediate return ends of the thin zigzag or expanded helical lines 24 and the current distributor as shown in FIG. 20. For one layer of the thin zigzag or expanded helical lines 24 intermediate the opposite sides of the furniture material 2, the return connector 7 connects the return terminal 5 with the current distributor 8 as shown in FIG. 21.

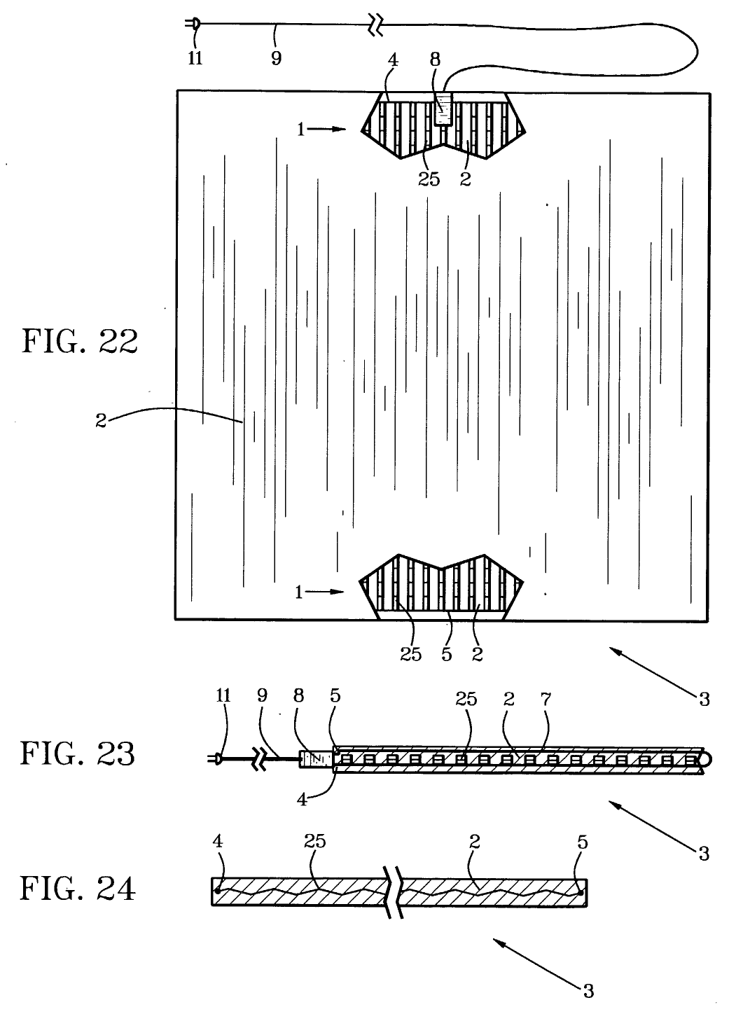

Referring to FIGS. 22-24, the lateral heating element can include a plurality of predeterminedly thin zigzag strips 25 of resistance material spaced apart predeterminedly side-by-side laterally. The input terminal 4 is in electrical communication intermediate the current distributor 8 and input ends of the thin zigzag strips 25. There is preferably only one layer of the zigzag strips 25 intermediate the opposite sides of the furniture material 2. The return connector 7 connects the return terminal 5 with the current distributor 8 as shown in FIG. 23. The zigzag strips 25 are seen from ends in FIG. 23 and from sides in FIG. 24.

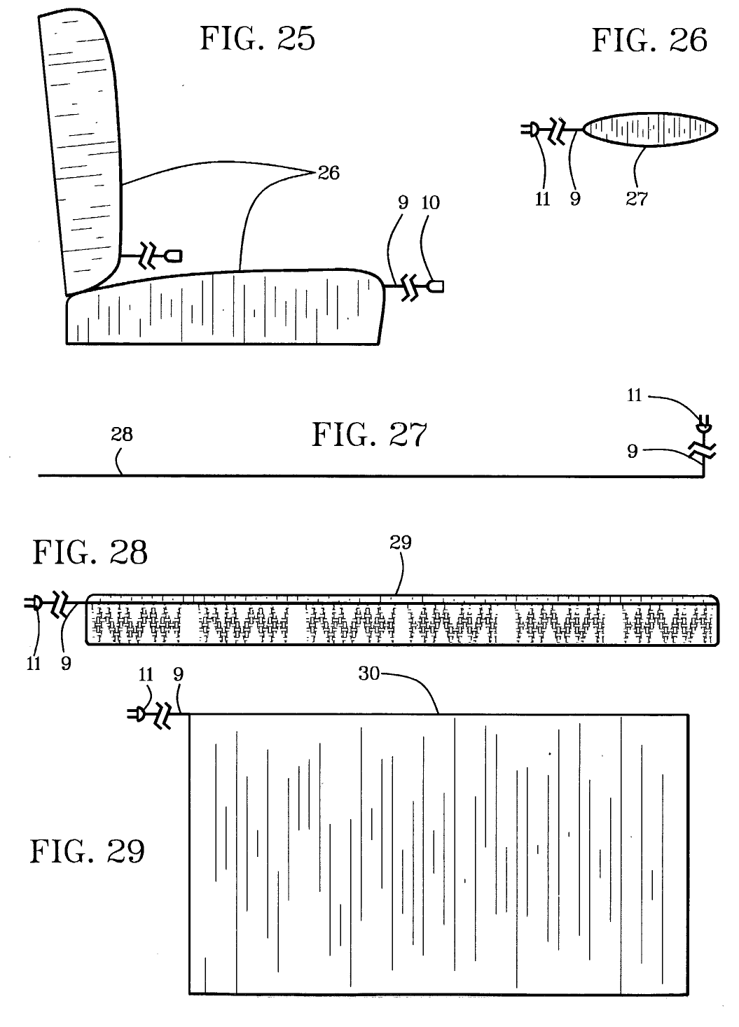

Referring to FIGS. 25-29, the heating article of furniture 3 can include a seat cover 26 as shown in FIG. 25, a pillow cover 27 as shown in FIG. 26, a quilt 28 as shown in FIG. 27, a mattress cover 29 as shown in FIG. 28, or a wall cover 30 as shown in FIG. 29. Other heating articles of furniture 3 also can be included. For seat covers 26 for vehicles, the DC plug 10 is preferred. For applications separately from vehicles, the AC plug 11 is preferred.

Lateral heating elements 1 that are pliable and bendable are preferable for cushioned heating articles of furniture 3. This includes all but the thin sheet 20 for most uses. All of the other lateral heating elements 1 taught by this invention and others foreseeable within its description can be made pliable and bendable. All can be attached to nearly any known fabric, including cloth, vinyl, leather or rubberlike material as the furniture material 2. The furniture material 2 can be made as smooth, rough, moisture proof, permeable, impermeable, pliable or stiff as desired for use with a selected lateral heating element 1 that can be made to have corresponding characteristics and features.

The thin sheet 20 without perforations 21, however, is particularly advantageous for the wall covers 30 that can provide cleaner, less expensive and more conveniently controllable room heating than present room-heating systems.

A new and useful heating-element-embedded material having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A heating-element-embedded material comprising:
a lateral heating element embedded in furniture material;
the lateral heating element having series-parallel heating-resistor communication of electrical current intermediate an input terminal and a return terminal on a heating article of furniture;
the furniture material having predetermined features for making and covering heating articles of furniture designedly; and
the lateral heating element being embedment-positioned predeterminedly on the furniture material.

2. The heating-element-embedded material of claim 1 wherein:
the lateral heating element includes a resistance-wire net.

3. The heating-element-embedded material of claim 2 wherein:
the resistance-wire net is oriented with first strands extended obliquely in a direction of a first side of the heating article of furniture and with second strands extended obliquely in a direction of a second side of the heating article of furniture.

4. The heating-element-embedded material of claim 2 wherein:
the resistance-wire net is oriented with the first strands parallel and the second strands orthogonal to an axis of current flow intermediate the input terminal and the return terminal.

5. The heating-element-embedded material of claim 1 wherein:
the lateral heating element includes a predeterminedly thin sheet of resistance material.

6. The heating-element-embedded material of claim 5 wherein:
the predeterminedly thin sheet of resistance material is perforated predeterminedly for permeability.

7. The heating-element-embedded material of claim 1 wherein:
the lateral heating element includes a plurality of predeterminedly thin strips of resistance material that are spaced apart predeterminedly edge-to-edge laterally;
the input terminal is in electrical communication intermediate the current distributor and input ends of the predeterminedly thin strips; and
the return terminal is in electrical communication intermediate return ends of the predeterminedly thin strips and the current distributor.

8. The heating-element-embedded material of claim 1 wherein:
the lateral heating element includes a plurality of predeterminedly thin single lines of resistance material that are spaced apart predeterminedly side-by-side laterally;
the input terminal is in electrical communication intermediate the current distributor and input ends of the predeterminedly thin single lines; and
the return terminal is in electrical communication intermediate return ends of the predeterminedly thin single lines and the current distributor.

9. The heating-element-embedded material of claim 1 wherein:
the lateral heating element includes a plurality of predeterminedly thin yarn lines of resistance material that are spaced apart predeterminedly side-by-side laterally;
the input terminal is in electrical communication intermediate the current distributor and input ends of the predeterminedly thin yarn lines; and
the return terminal is in electrical communication intermediate return ends of the predeterminedly thin yarn lines and the current distributor.

10. The heating-element-embedded material of claim 1 wherein:
the lateral heating element includes a plurality of predeterminedly thin expanded helical lines of resistance material that are spaced apart predeterminedly side-by-side laterally;
the input terminal is in electrical communication intermediate the current distributor and input ends of the predeterminedly thin expanded helical lines; and
the return terminal is in electrical communication intermediate return ends of the predeterminedly thin expanded helical lines and the current distributor.

11. The heating-element-embedded material of claim 1 wherein:
the lateral heating element includes a plurality of predeterminedly thin zigzag strips of resistance material that are spaced apart predeterminedly side-by-side laterally;
the input terminal is in electrical communication intermediate the current distributor and input ends of the predeterminedly thin zigzag strips; and
the return terminal is in electrical communication intermediate return ends of the predeterminedly thin zigzag strips and the current distributor.

12. The heating-element-embedded material of claim 1 wherein:
the furniture material includes predetermined rubber likeness.

13. The heating-element-embedded material of claim 1 wherein:
the furniture material includes predetermined vinyl likeness.

14. The heating-element-embedded material of claim 1 wherein:
the furniture material includes predetermined cloth likeness.

15. The heating-element-embedded material of claim 1 wherein:
the furniture material includes predetermined smoothness.

16. The heating-element-embedded material of claim 1 wherein:
the furniture material includes predetermined roughness.

17. The heating-element-embedded material of claim 1 wherein:
the furniture material includes predetermined moisture-proofness.

18. The heating-element-embedded material of claim 1 wherein:
the furniture material includes predetermined permeableness.

19. The heating-element-embedded material of claim 1 wherein:
the furniture material includes predetermined impermeableness.

20. The heating-element-embedded material of claim 1 wherein:
the heating article of furniture includes a seat cover.

21. The heating-element-embedded material of claim 1 wherein:
the heating article of furniture includes a heating pad.

22. The heating-element-embedded material of claim 1 wherein:
the heating article of furniture includes a mattress cover.

23. The heating-element-embedded material of claim 1 wherein:
the heating article of furniture includes a bed quilt.

24. The heating-element-embedded material of claim 1 wherein:
the heating article of furniture includes a pillow cover.

25. The heating-element-embedded material of claim 1 wherein:
the heating article of furniture includes a wall cover.

26. The heating-element-embedded material of claim 1 wherein:
the heating article of furniture includes a heating sheet having a predeterminedly fitted carrying and use container that is use articulated, removable and replaceable selectively.

27. The heating-element-embedded material of claim 1 wherein:
the lateral heating element is embedment-positioned predeterminedly proximate a single side of the furniture material.

28. The heating-element-embedded material of claim 1 wherein:
the lateral heating element is embedment-positioned predeterminedly proximate two oppositely disposed sides of the furniture material.

29. The heating-element-embedded material of claim 1 wherein:
the lateral heating element is embedment-positioned predeterminedly intermediate the two oppositely disposed sides of the furniture material.

30. The heating-element-embedded material of claim 1 wherein:
the input terminal and the return terminal include lateral lead lines which are connected to predetermined lateral heating elements for series-parallel heating resistance.

31. The heating-element-embedded material of claim 1 wherein:
the input terminal and the return terminal are connected to a current distributor that is attached designedly to an electrical cord.

32. The heating-element-embedded material of claim 32 wherein:
the electrical cord includes a DC plug.

33. The heating-element-embedded material of claim 32 wherein:
the electrical cord includes an AC plug.
